(19) United States
(12) Patent Application Publication
(10) Pub. No.: US 2004/0168157 A1
(43) Pub. Date: Aug. 26, 2004

(54) System and method for creating a process invocation tree

(76) Inventors: Robert Hundt, Santa Clara, CA (US); Stephen Williams, Santa Cruz, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/368,944

(22) Filed: Feb. 18, 2003

(51) Int. Cl. G06F 9/44

(52) U.S. Cl. 717/130

(57) ABSTRACT

A computer-implemented method for creating a process invocation tree includes identifying an event indicating that a parent process of interest has invoked a child process, suspending execution of the child process, collecting information-of-interest associated with the invocation of the child process, and resuming execution of the child process.

### BACKGROUND

Many complex software systems employ multiple executables, scripts, and processes. An executable is a file in a format that computer hardware can directly execute. Unlike source files that are typically read and understood by humans, executable files are intended to be run or executed by hardware and are not intended to be read by humans. A source file is transformed into an executable by a compiler or an assembler.

A script is a list of commands that can be executed without user interaction (e.g., a macro or a batch file). A script language is a simple programming language that allows an operator to write scripts. Under the UNIX® operating system and various proprietary variations, many software systems are started and maintained with the help of shell scripts. UNIX® is a trademark of the American Telephone and Telegraph Corporation of New York, N.Y., U.S.A.

“Shell” is another term for user interface. Sometimes called the command shell, a shell is the command processor interface. The command processor is the program that executes operating system commands. Therefore, the “shell” is the part of the command processor that accepts commands. UNIX®-based systems offer a choice between several different shells, the most popular being the C shell, the Bourne shell, and the Korn shell. Each offers a somewhat different command language.

A “process” is commonly defined as an address space, a control thread operating within the address space, and the set of system resources needed for operating the thread. Therefore, a “process” includes the commands or instructions (i.e., the executable), the data on which the executable operates, the memory resources, and input/output resources.

Program verification and performance testing encompasses execution of the program as a process thread to test if the process executes in the correct way or if undesired or unexpected events occur. To understand the interaction and flow of a complex software system, it is often desired to understand which executables are started, the parameters with which the executables are started, and the state of the programming environment when the executables are started. It is also frequently desired to focus attention on the invocation of a particular process of interest. Generally, a programmer is interested in the processes' creation, the parameters and environment passed to the process, etc. Information concerning a processes' invocation is especially useful when unexpected results are observed in complex software systems.

For example, the UNIX® shells offer the “xtrace” capability. “Xtrace” enables a user to request invocation information regarding each executable invoked from the shell. The invocation information can be directed to a file, a display device, and/or a hardcopy device in communication with the command processor. However, “xtrace” only reflects information for processes created by the shell. When a process created by the shell creates a new process, for example by executing the system fork()/vfork()/exec() functions, the “xtrace” mechanism is insufficient as it does not reflect how the new processes are created.

Consequently, improved ways are needed to understand the creation of all processes and the starting of all executables in a process invocation tree.

### SUMMARY

An embodiment of a computer-implemented method for creating a process invocation tree includes identifying an event indicating that a parent process of interest has invoked a child process, suspending execution of the child process, collecting information-of-interest associated with the invocation of the child process, and resuming execution of the child process.

### BRIEF DESCRIPTION OF THE DRAWINGS

A system and method for creating a process invocation tree are illustrated by way of example and not limited by the implementations depicted in the following drawings. The components in the drawings are not necessarily to scale. Emphasis instead is placed upon clearly illustrating the principles of the present system and method. Moreover, in the drawings, like reference numerals designate corresponding parts throughout the several views.

FIG. 1 is a diagram depicting an embodiment of a dynamic instrumentation system in accordance with one embodiment of the system.

FIG. 2 is a flowchart of a process for performing dynamic instrumentation in accordance with one embodiment of the method.

FIG. 3A is a flowchart of a process for allocating shared memory between an instrumented process and the application executable.

FIGS. 3B-3D illustrate a sequence of memory states resulting from the process of allocating shared memory.

FIG. 4 is a block diagram that illustrates the functional layout of memory of an executable application which has a function entry point patched with a breakpoint.

FIG. 5 is a block diagram that illustrates the functional layout of memory of an executable application after an instrumented version of a function has been created.

FIG. 6 is a flow diagram that illustrates the interaction between a process that controls dynamic instrumentation, an executable application, and an instrumented function.

FIG. 7 is a schematic diagram depicting an original function and a corresponding instrumented function created by an embodiment of a dynamic instrumentation system in accordance with the system and method for creating a process invocation tree.

FIG. 8 is a schematic diagram depicting a computing device in accordance with an embodiment of a process invocation spy.

FIG. 9 is a functional block diagram of an embodiment of the process invocation spy of FIG. 8.

FIG. 10 is a flow diagram illustrating an embodiment of a method for creating a process invocation tree.

FIG. 11 is a flow diagram illustrating another embodiment of a method for creating a process invocation tree.

### DETAILED DESCRIPTION

A process invocation spy provides a mechanism that enables an operator to log or otherwise record an entire process invocation history for processes generated by a parent process under a command shell. Multiple embodiments are described below with regard to the figures. In one embodiment, the process invocation spy is embedded within a software tool configured to perform dynamic binary instrumentation of designated functions. In another embodiment, the process invocation spy is a separate tool. In this alternative embodiment, the process invocation spy uses the operating system's debug interface to gather statistics on an uninstrumented executing process.

When an operator is interested in all process invocations initiated under a particular executable, or script, the process invocation spy uses the debugging interface provided by the operating system (e.g., ttrace for HP-UX) to create and monitor system events generated by a process of interest. In particular, the process invocation spy is programmed to log or otherwise record operating system specific events responsive to functions that generate a child process from a parent process of interest. For example, the system “fork” and “vfork” functions generate a child process using the address space of the parent process. In addition to monitoring system events responsive to the fork and vfork functions, the process invocation spy monitors “exec” and “exit” system events generated by the various processes and can monitor other system events as may be required to satisfactorily collect desired information related to the process invocation history under specific operating systems.

When designated system events are detected by the process invocation spy, the process invocation spy initiates logic configured to collect information regarding the events into a process invocation store. When system events indicate that a new process has been created, the process invocation spy suspends execution of the process and collects information about the new process and forwards the collected information to the process invocation store. The information includes all program arguments (e.g., command line arguments, flags, switches, etc.), the state of the programming environment when the process was invoked (e.g., global variables, file paths, etc.), as well as timing information. The information may be augmented with operator selectable information such as system time, user rights, system state, etc.

Any of a number of initiating triggers can be used to forward the stored information (i.e., the process invocation tree) to a file or one or more output devices. For example, the stored information can be piped to a file, sent to a printer or other hard copy device, and/or sent to a display device in communication with the command processor. The information (including any augmented information) can be output from the process invocation store upon completion of the process invocation tree, upon operator request, after a timer has extinguished, or any other method.

In accordance with one embodiment, the process invocation spy is integrated with a software tool programmed to enable dynamic binary instrumentation of one or more target processes to monitor and analyze run-time performance of a software system. While the process invocation spy can be integrated with software tools that modify executables or target processes during run-time, the process invocation spy does not rely on any of the processing techniques that enable dynamic binary instrumentation. Consequently, in some embodiments the process invocation spy can be implemented as an autonomous program analysis tool.

A process invocation spy and a method for creating a process invocation tree having been summarized above, reference will now be made in detail to the description of the system and method as illustrated in the drawings. Dynamic instrumentation enables instrumentation data for an executable program (also, “executable application” or “application”) to be obtained while the application is executing. This is typically accomplished without any pre-processing, e.g., recompilation or relinking, of the application prior to execution. A system is described below which performs dynamic instrumentation of an application. Those skilled in the art of complex software systems will understand that by executing appropriately instrumented code, a dynamic instrumentation scheme provides increased knowledge into the run-time dynamics of the instrumented functions. For example, an instrumented function may provide information regarding program performance (e.g., a counter that reflects the number of times a particular process exercised a particular function), verify correctness, and test for correct run-time operation.

The term “function” refers to named sections of code that are callable in the source program and encompasses routines, procedures, methods, and other similar constructs known in the art. Functions in source code are compiled into segments of executable code. For convenience, the segments of executable code that correspond to functions in the source code are also referred to as “functions.”

A function is a set of instructions beginning at an entry point and ending at an endpoint. The entry point is the address at which execution of the function begins as the target of a branch instruction. The endpoint is the instruction of the function from which control is returned to the point in the program at which the function was initiated. For functions having multiple entry points and/or multiple endpoints, the first entry point and the last endpoint define the function.

In various embodiments, a dynamic binary instrumenter uses function entry points and endpoints to support analysis of executable program code. Compiler-generated checkpoints can be used to identify function entry points and endpoints in executable program code. Compiler-generated checkpointing is described in patent application having patent application Ser. No. 09/702,590 entitled, “COMPILER-BASED CHECKPOINTING FOR SUPPORT OF ERROR RECOVERY,” by Thompson et al., filed on Oct. 31, 2000, the contents of which are incorporated herein by reference. In other embodiments, a dynamic binary instrumenter is programmed to determine the type of call made to functions of an application-of-interest. Function calls can be direct and indirect. Direct calls are function calls to a specific memory address. Indirect calls are function calls to an address that is not known at compile time. A method for identifying function call type is described in patent application Ser. No. 10/263,151, entitled, “DYNAMIC INSTRUMENTATION OF AN EXECUTABLE PROGRAM,” by Robert Hundt, filed on Oct. 2, 2002, attorney docket number 200206047-1, the contents of which are also incorporated herein by reference.

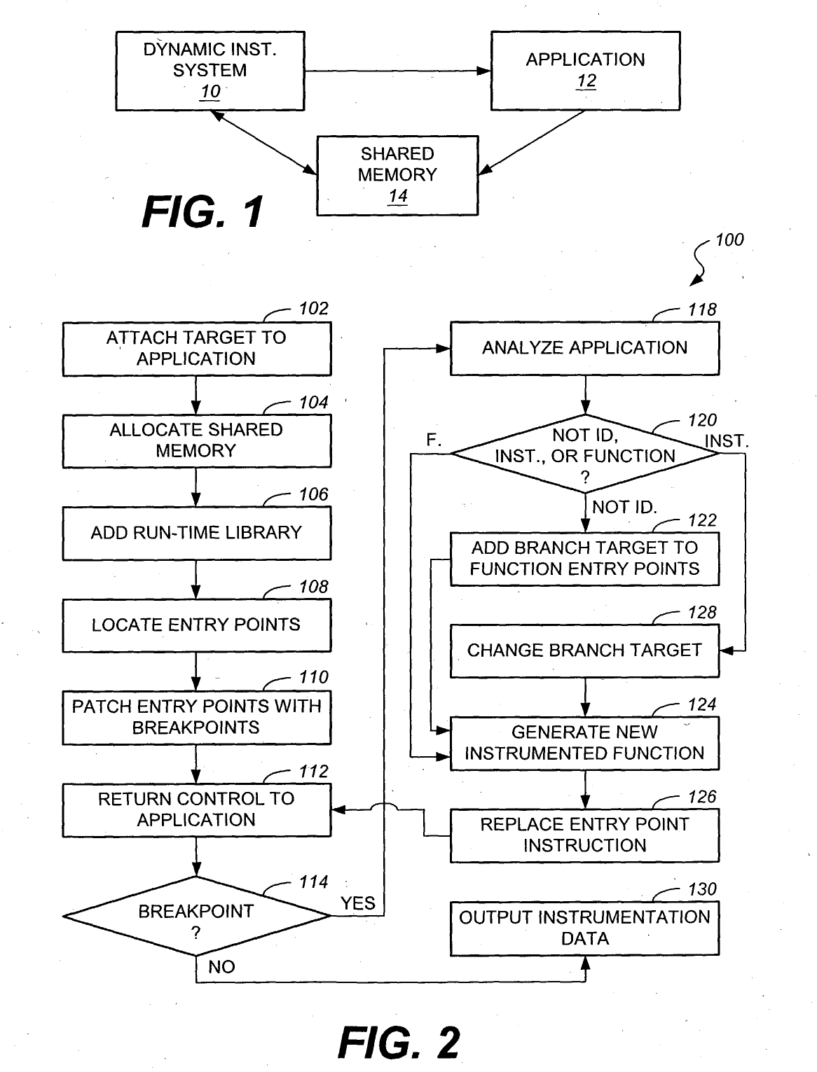

A dynamic instrumentation system 10 in accordance with one embodiment of the system and method for creating a process invocation tree is depicted schematically in FIG. 1. As shown in FIG. 1, dynamic instrumentation system 10 communicates with an application 12 so that dynamic instrumentation can be performed. In particular, dynamic instrumentation system 10 creates instrumented versions of functions of application 12 when the functions are invoked, and thereafter executes the instrumented functions instead of the original functions. To perform dynamic instrumentation, both the dynamic instrumentation system 10 and the application 12 communicate with shared memory 14, as will be described in detail later.

A process for performing dynamic instrumentation in accordance with one embodiment of the system and method for creating a process invocation tree is depicted in FIG. 2. The process generally entails generating instrumented functions instead of the original functions in the application. Note that only those functions that are executed typically are instrumented. This can be especially useful for instrumentation of large-scale applications, where significant portions of the executable code may not be exercised during nominal operation of the application(s).

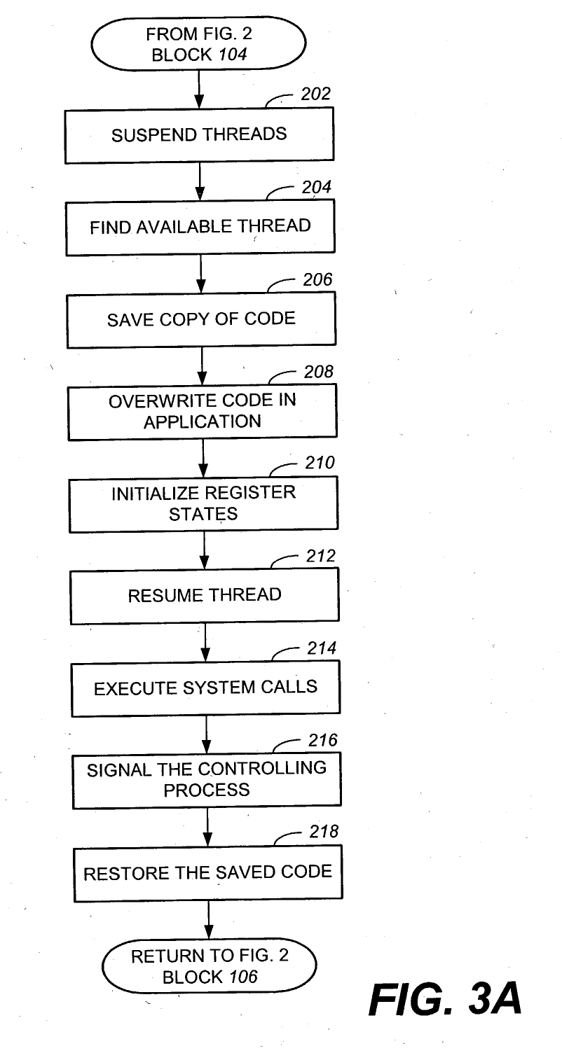

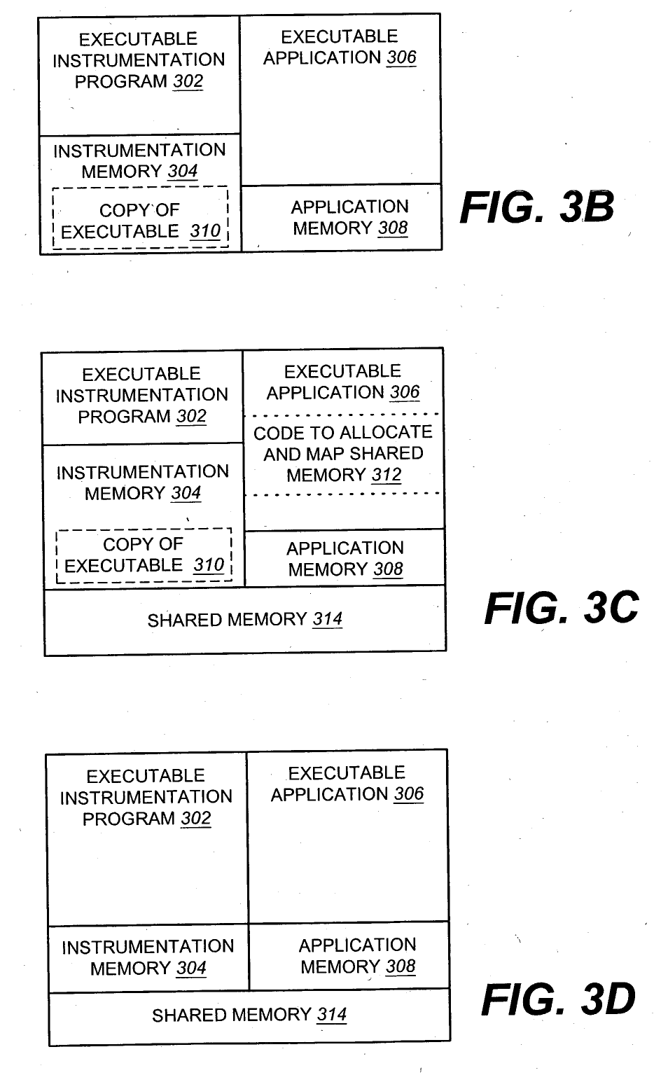

As shown in FIG. 2, the process 100 begins at block 102, where an instrumentation process attaches to a target executable application and obtains control. Those skilled in the art should understand that this can be accomplished, for example, using known, conventional techniques. At block 104, the process allocates and maps shared memory for use by the instrumentation process and the executable application. The process of allocating and mapping the shared memory is described further in FIG. 3A.

At block 106, optional run-time libraries are added for dynamic instrumentation. These run-time libraries include, for example, code to dynamically increment the number of counters for indirect branch targets and code to perform a system call to register an instrumented function to the dynamic loader.

At block 108, entry points of the functions in the executable application are located. In addition to those methods that are known in the art, various other techniques for finding function entry points are described in the patent/application entitled, “ANALYSIS OF EXECUTABLE PROGRAM CODE USING COMPILER GENERATED FUNCTION ENTRY POINTS AND ENDPOINTS WITH OTHER SOURCES OF FUNCTION ENTRY POINTS AND ENDPOINTS”, to Hundt et al., having patent/application Ser. No. 09/833,249, the contents of which is incorporated herein by reference.

Each of the function entry points is patched with a breakpoint at block 110. The instructions at the function entry points are saved in a table and/or other data structures so that they can be restored at the appropriate time. At block 112, control is returned to the executable application.

When a breakpoint is encountered in the executable application, control is returned to the instrumentation process, and decision block 114 directs the process to block 118. At block 118 the executable is analyzed to find the function entry point for the encountered breakpoint, determine the length of the function, and analyze the function to identify target addresses of branch instructions (“branch targets”). For newly identified branch targets, the process is directed to block 122, where the branch targets are added to the list of function entry points, and the instruction at the branch target is patched with a breakpoint. The instruction at the branch target is saved, before the instruction is patched to enable subsequent restoration. The process is then directed to block 124.

At block 124, a new instrumented function is generated and stored in the shared memory. The function of the executable application from which the new instrumented function is generated is that from which control was returned to the instrumentation process via the breakpoint (block 114). In generating the new instrumented function, the saved entry point instruction is restored as the first instruction of the new instrumented function in the shared memory. At block 126, the entry point instruction in the executable application is replaced with a long-branch instruction having as a target the new instrumented function in the shared memory. The instrumentation process then continues at block 112, where control is returned to the executable application to execute the new instrumented function.

Returning now to block 120, if the branch target(s) identified at block 118 has already been instrumented, the branch target is replaced with the address in shared memory of the instrumented function (block 128). If the branch instruction is subsequently executed, control will jump to the instrumented function. The instrumentation process then continues at block 124 as described above. For branch targets that have already been identified as functions, the process continues from block 120 directly to block 124.

Returning now to block 114, when the end of the executable application is reached, control is returned to the instrumentation process, and the instrumentation process continues at block 130. Selected instrumentation data that were gathered in executing the application are output at block 130 to complete the instrumentation process.

FIG. 3A is a flowchart of a process in accordance with one embodiment of the invention for allocating shared memory for an instrumentation process and application executable. FIGS. 3B-3D illustrate a sequence of memory states resulting from the process of allocating the shared memory depicted in FIG. 3A. Thus, references are made to the elements of FIGS. 3B-3D in the description of FIG. 3A.

Initially, the executable instrumentation program 302 (FIG. 3B) has a memory segment 308 and the application executable has memory segment 306. At block 202, all threads of the executable application are suspended. At block 204, an available thread is selected from the application. A thread is unavailable if it is in the midst of processing a system call. If no threads are available, then all the threads are restarted, and the application is allowed to continue to execute until one of the threads returns from a system call. When a thread returns from a system call, the threads are again suspended, and the available thread is selected.

At block 206, the process selects a segment of code within the executable application and saves a copy of the segment 310 in instrumentation memory 304. In addition, the states of registers of the application are saved in instrumentation memory segment 304.

At block 208, the selected segment of code in the application is overwritten with code segment 312 (“injected code”), which includes instructions to allocate and map shared memory (FIG. 3C). At block 210, the registers are initialized for use by the selected thread, and the beginning address of the code segment 312 is stored in the program counter. At block 212, the execution of the thread is resumed at the code segment 312.

In executing code segment 312, system calls are executed (block 214) to allocate the shared memory segment 314 and map the shared memory segment for use by the executable instrumentation program 302 and the executable application 306. A breakpoint at the end of the injected code 312 signals (block 216) the executable instrumentation program 302 that execution of the injected code is complete.

At block 218, the executable instrumentation program 302 restores the saved copy of code 310 to the executable application 302 (FIG. 3D) and restores the saved register values. The saved program counter is restored for the thread used to execute the injected code. Control is then returned to block 106 of FIG. 2.

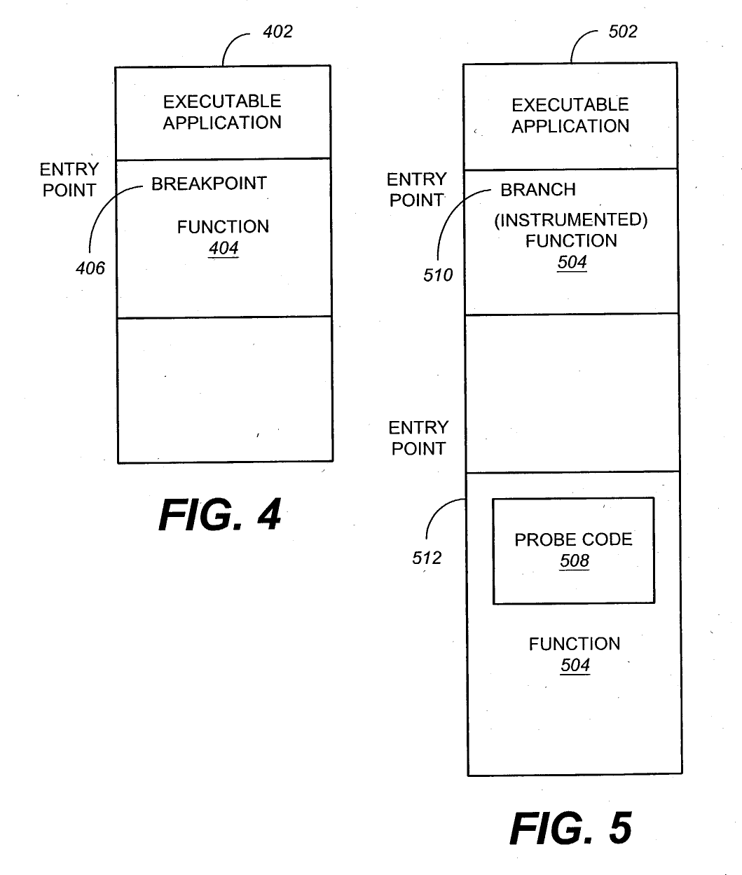

FIGS. 4 and 5 are block diagrams that illustrate the functional layout of memory used by an executable application during an instrumentation process. As shown and described in the process of FIG. 2 (blocks 108-110), the entry points of the functions in the executable application 402 are patched with breakpoints. For example, the entry point of function 404 is patched with breakpoint 406. When breakpoint 406 is encountered while executing the application 402, a new instrumented version of function 404 is generated (FIG. 2, blocks 124 and 126).

The new executable application 502 (FIG. 5) includes the instrumented version of the function 504, which is stored in the shared memory segment 314 (FIG. 3D). The instrumented function 504 includes probe code 508, which, when executed within function 504, generates selected instrumentation data. For example, the probe code 508 can count the number of times the function 504 is executed. It should be understood that the program logic originally set forth in function 404 is preserved in function 504.

To execute the instrumented function 504, the instruction at the entry point of function 504 is replaced with a long-branch instruction 510 having as an address the entry point 512 of instrumented function 504. In addition, the addresses of branch instructions elsewhere in application 402 that target function 404 are changed to reference instrumented function 504.

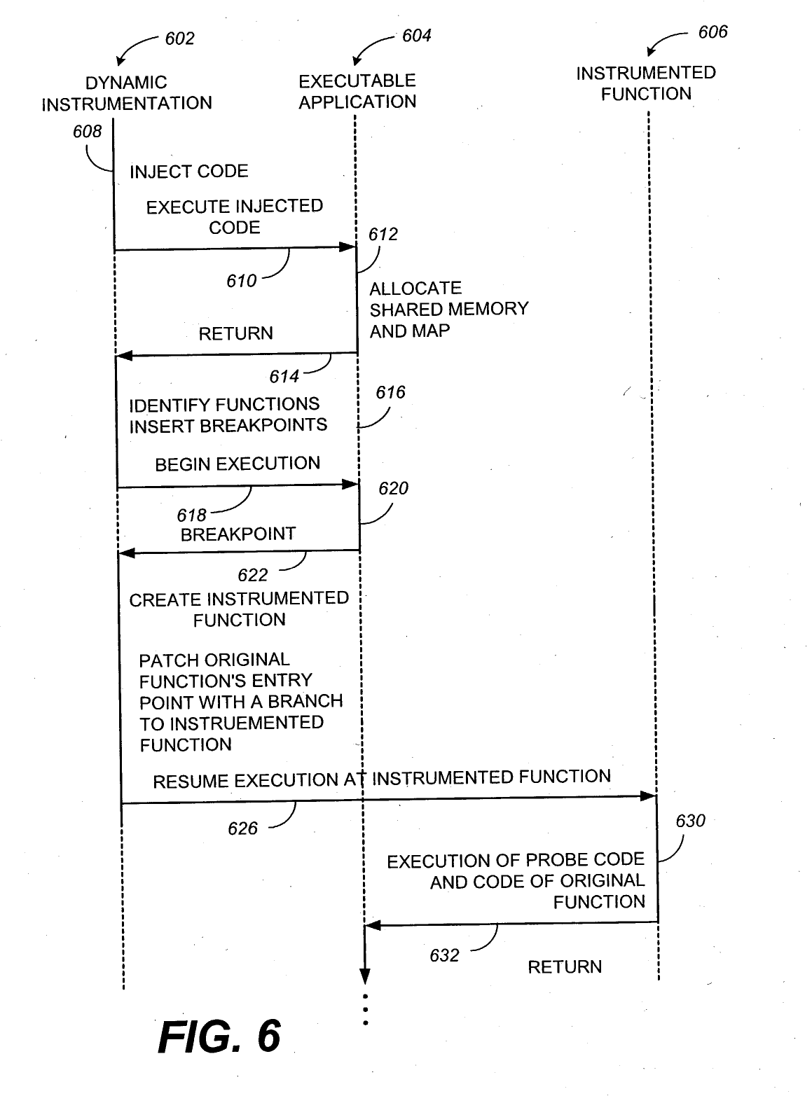

FIG. 6 is a flow diagram that illustrates the interaction between the process that controls dynamic instrumentation 602, the executable application 604, and the instrumented function 606. The vertical portions of the directional lines represent execution of code indicated by the respective headers above the lines. The horizontal portions indicate a transfer of control from one set of code to another set of code.

The control flow begins with the dynamic instrumentation code injecting code (608) into the executable application 604 (e.g., FIG. 3C). Control is transferred (610) from the dynamic instrumentation code to the executable application code to execute the injected code. The executable application 604 allocates and maps (612) shared memory for use by the dynamic instrumentation and the executable application.

Control returns (614) to the dynamic instrumentation code, which then identifies functions in the executable application 604 and inserts breakpoints (616). Control is then transferred (618) to the executable application, which executes the application code (620) until a breakpoint is reached. The breakpoint indicates the beginning of a function. The breakpoint transfers control (622) back to the dynamic instrumentation code, and the dynamic instrumentation code creates an instrumented version of the function (FIG. 5) and patches the original function entry point with a branch to the instrumented function. Execution of the application 504 is then resumed (626) at the instrumented function 606.

The code of the instrumented function along with the probe code (FIG. 5, 508) is executed (630). Control is eventually returned (632) to execute other code in the application. The process then continues as described above with reference to FIG. 2.

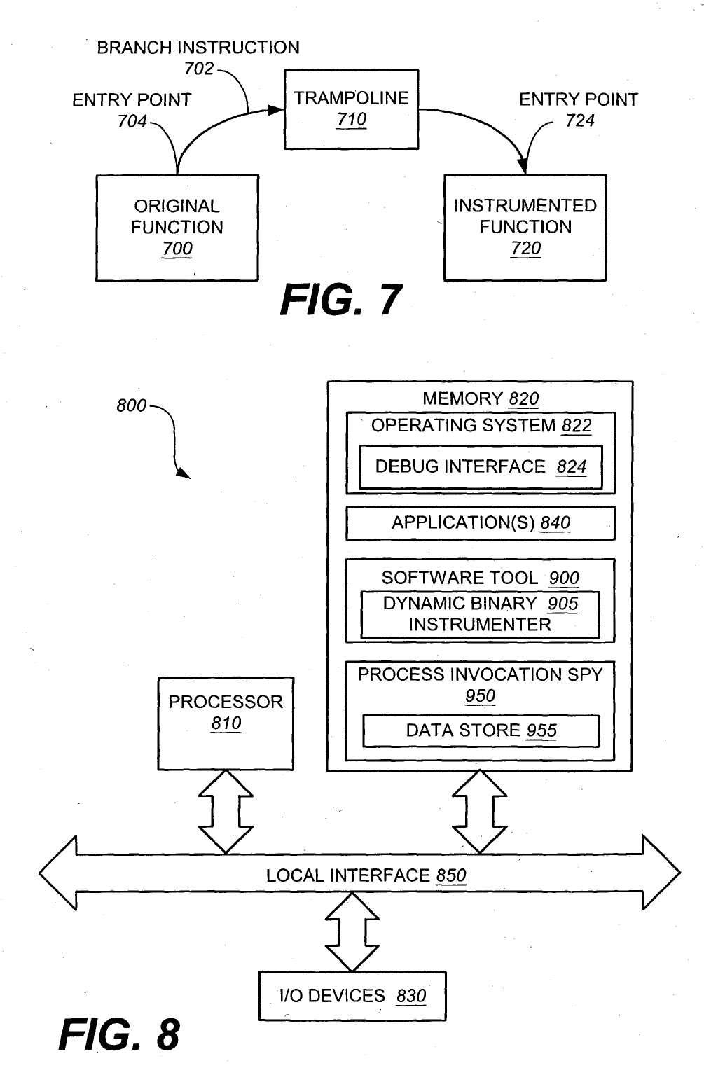

As mentioned before, embodiments of the present system and method for creating a process invocation tree enable the type of call used to invoke a function to be determined. In this regard, reference is made to FIG. 7, which is schematic diagram depicting an original function 700, a related instrumented function 720 and a branching instruction 702 that is used to patch function 700's entry point 704 with the entry point 724 of the instrumented function. Note that instead of directing calls from entry point 704 to 724 directly, the branching instruction directs calls to a trampoline 710, which then directs the calls to the entry point 724 of the instrumented function. Preferably, the trampoline 710 increments a counter each time a call is passed. Thus, information of the counter corresponds to the number of indirect calls used to invoke the function.

In particular, since the dynamic instrumentation process described above causes direct calls that target the original function 700 to be directed to the entry point 724 of the instrumented function 720 as direct calls, only those calls that are directed to the original function as indirect calls should use the original function entry point 704 after instrumentation. Therefore, by determining the number of calls directed to the original function entry point after instrumentation has taken place, the number of calls routed to the instrumented function entry point via the branching instruction corresponds to the number of indirect calls used to invoke the original function.

Reference is now directed to FIG. 8, which illustrates a functional block diagram of a general-purpose computing device 800. Generally, in terms of hardware architecture, as shown in FIG. 8, general-purpose computing device 800 includes a processor 810, memory 820, and input/output (I/O) device(s) 830 that are communicatively coupled via local interface 850.

Local interface 850 can be, for example but not limited to, one or more buses or other wired or wireless connections, as is known in the art or may be later developed. Local interface 850 may have additional elements, which are omitted for simplicity, such as controllers, buffers (caches), drivers, repeaters, and receivers, to enable communications. Further, local interface 850 may include address, control, and/or data connections to enable appropriate communications among the aforementioned components of the general-purpose computing device 800.

In the embodiment of FIG. 8, the processor 810 is a hardware device for executing software that can be stored in memory 820. The processor 810 can be any custom-made or commercially-available processor, a central-processing unit (CPU) or an auxiliary processor among several processors associated with the general-purpose computing device 800 and a semiconductor-based microprocessor (in the form of a microchip) or a macroprocessor.

The memory 820 can include any one or combination of volatile memory elements (e.g., random-access memory (RAM, such as dynamic-RAM or DRAM, static-RAM or SRAM, etc.)) and nonvolatile-memory elements (e.g., read-only memory (ROM), hard drives, tape drives, compact-disk drives-(CD-ROMs), etc.). Moreover, the memory 820 may incorporate electronic, magnetic, optical, and/or other types of storage media now known or later developed. Note that the memory 820 can have a distributed architecture, where various components are situated remote from one another, but accessible by processor 810.

The software in memory 820 may include one or more separate programs, each of which comprises an ordered listing of executable instructions for implementing logical functions. In the example of FIG. 8, the software in the memory 820 includes application(s) 840, software tool 900, and process invocation spy 950 that function as a result of and in accordance with operating system 822. Application(s) 840 include one or more executables that operate under a shell. As described above, the executables may be part of a process that an operator is interested in monitoring during execution.

Operating system 822 preferably controls the execution of computer programs, such as application(s) 840, software tool 900, and process invocation spy 950 and provides scheduling, input-output control, file and data management, memory management, and communication control and related services.

As illustrated in FIG. 8, operating system 822 includes debug interface 824. As explained above, debug interface 824 includes function calls and responds to system events associated with creating a process from a parent process that enable a process invocation spy 950 to suspend and resume execution of a newly created child process. Debug interface 824 also provides a convenient mechanism for collecting information associated with child process invocation.

In an embodiment, software tool 900 is one or more source programs, executable programs (object code), scripts, or other collections each comprising a set of instructions to be performed. As shown in FIG. 8, software tool 900 is configured with a dynamic binary instrumenter 905 that is separate and distinct from process invocation spy 950.

In the embodiment depicted in FIG. .8, process invocation spy 950 is implemented autonomously from software tool 900 and the dynamic binary instrumenter 905. As further illustrated in FIG. 8, process invocation spy 950 is allotted a portion of memory 820 labeled data store 955. It will be well understood by one skilled in the art, after having become familiar with the teachings of the system and method for creating a process invocation tree, that applications 840, software tool 900 (including the dynamic binary instrumenter 905), and the process invocation spy 950 may be written in a number of programming languages now known or later developed.

I/O device(s) 830 may include, but are not limited to, a keyboard, a mouse, or other interactive-pointing devices, voice-activated interfaces, or other operator-machine interfaces (omitted for simplicity of illustration) now known or later developed. Each of the various I/O device(s) 830 may be in communication with the processor 810 and/or the memory 820 via the local interface 850. Data received from an I/O device 830 may take the form of a command, command arguments, a script, etc.

I/O device(s) 830 may also include a video interface that supplies a video-output signal to a display monitor (not shown) associated with the general-purpose computing device 800. Display devices that can be associated with the general-purpose computing device 800 are conventional CRT based displays, liquid-crystal displays (LCDs), plasma displays, image projectors, or other display types now known or later developed. It should be understood, that various I/O device(s) 830 in addition to those described above may also be integrated via local interface 850 and/or other interfaces to other well-known devices such as plotters, printers, copiers, etc.

When the general-purpose computing device 800 is in operation, the processor 810 is configured to execute software stored within the memory 820, to communicate data to and from the memory 820, and to generally control operations of the general-purpose computing device 800 pursuant to the software. The operating system 822, application(s) 840, software tool 900, and process invocation spy 950, in whole or in part, but typically the latter, are read by the processor 810, perhaps buffered within the processor 810, and then executed.

It should be understood that process invocation spy 950 can be embodied in any computer-readable medium for use by or in connection with an instruction-execution system, apparatus, or device, such as a computer-based system, processor-containing system, or other system that can fetch the instructions from the instruction-execution system, apparatus, or device, and execute the instructions. In the context of this disclosure, a “computer-readable medium” can be any means that can store, communicate, propagate, or transport a program for use by or in connection with the instruction-execution system, apparatus, or device. The computer-readable medium can be, for example but not limited to, an electronic, magnetic, optical, electromagnetic, infrared, or semiconductor system, apparatus, device, or propagation medium now known or later developed. Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Those skilled in the art will understand that various portions of process invocation spy 950 can be implemented in hardware, software, firmware, or combinations thereof. In an embodiment, process invocation spy 950 is implemented using a combination of hardware and software or firmware that is stored in memory and executed by a suitable instruction-execution system. If implemented solely in hardware, as in an alternative embodiment, process invocation spy 950 can be implemented with any or a combination of technologies which are well-known in the art (e.g., discrete-logic circuits, application-specific integrated circuits (ASICs), programmable-gate arrays (PGAs), field-programmable gate arrays (FPGAs), etc.), and/or later developed technologies. In an embodiment, the functions of the process invocation spy 950 are implemented in a combination of software and data executed and stored under the control of the general-purpose computing device 800. It should be noted, however, that the process invocation spy 950 is not dependent upon the nature of the underlying computing device and/or upon the operating system in order to accomplish designated functions.

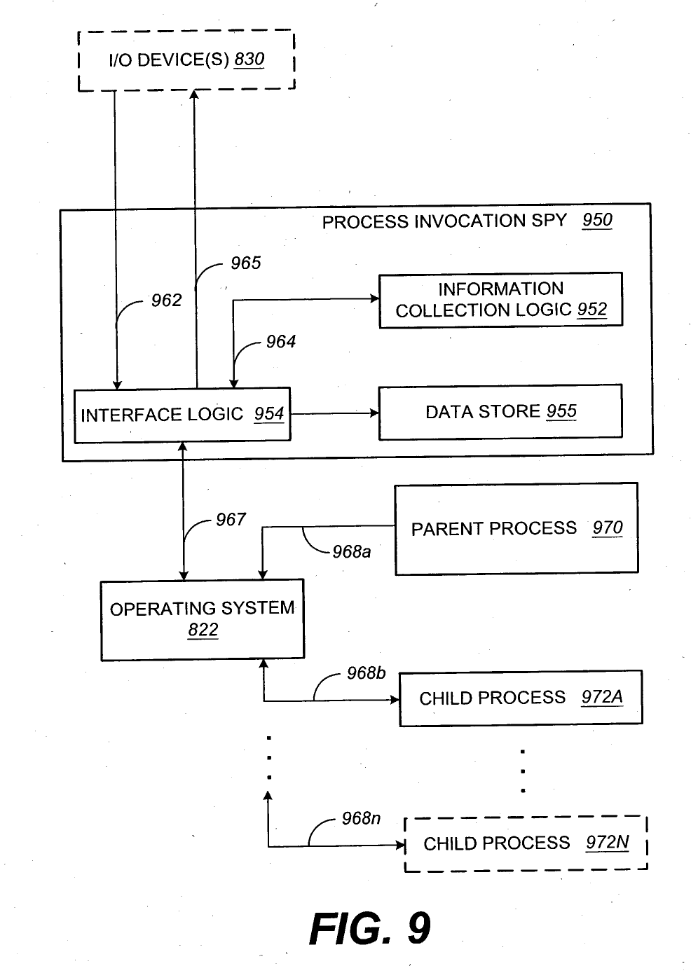

Reference is now directed to FIG. 9, which presents an embodiment of a functional block diagram of process invocation spy 950. As illustrated in FIG. 9, process invocation spy 950 comprises information collection logic 952, interface logic 954, and data store 955. Information collection logic 952 and data store 955 communicate with external processes via interface logic 954 and operating system 822 debug interfaces. Interface logic 954 receives an initiation command from I/O device(s) 830 via command interface 962. The initiation command contains information identifying a parent-process of interest (e.g., parent process 970). The initiation command may also contain information identifying one or more optional parameters-of-interest that are desired in the process invocation information log that will be created and stored in data store 955.

When process invocation spy 950 receives an initiation command, interface logic 954 forwards indicia of any requested optional system level parameters desired to be recorded when the parent process of interest creates a child process via link 964 to the information correction logic 952. The indicia can be encoded in flags or software switches set by an interested operator and/or other software tools in communication with processor 810 and I/O device(s) 830 (FIG. 8).

Interface logic 954 also waits for operating system level events from parent process of interest 970 along link 967. Interface logic 954 recognizes operating system level events that indicate that parent process 970 is about to create child process 972A. Upon receiving such an event, interface logic 954 issues a command via operating system 822 to suspend child process 972a. In addition, interface logic 954 buffers the process identifier of child process 972A and responds by monitoring operating system level events that indicate that child process 972A is creating another child process 972B. As indicated in the functional block diagram of FIG. 9, interface logic 954 is configured to monitor any number of processes invoked under the control of parent process 970.

After interface logic 954 suspends each child process 972A . . . 972N, information collection logic 952 collects and records the process identifiers of parent process 970 and child process 972x, as well as default information regarding the child process' invocation. Default information may include system time, system state, user rights, command line arguments used to configure the child process 972x, etc. When the command initiating the process invocation spy 950 includes indicia of other parameters-of-interest, such as global variables, directory paths, etc. information collection logic 952 collects these parameters as well for each subsequently invoked child process 972N. Once process invocation information is collected, information logic 952 is configured to forward the information in an organized fashion to data store 955. Information collection logic 952 also notifies interface logic 954 that the presently suspended child process 972N should be resumed.

As further illustrated in FIG. 9, process invocation information collected in data store 955 can be forwarded via interface logic 954 and data link 965 to I/O device(s) 830. Data transfers from data store 955 to I/O device(s) 830 can occur in accordance with a schedule, upon termination of the parent process 970, receiving a user request, or any other related method.

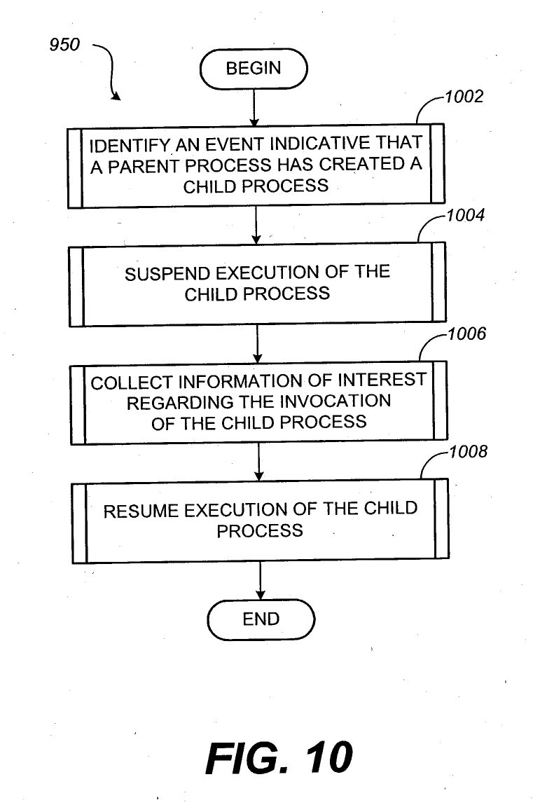

FIG. 10 is a flow diagram illustrating an embodiment of a method for creating a process invocation tree. Process invocation spy 950 begins the method by identifying an operating system level event that indicates that a parent process has created a child process as indicated in block 1002. Next, as shown in block 1004, process invocation spy 950 suspends execution of the child process. In block 1006, the process invocation spy collects information of interest regarding the invocation of the child process. For example, the process invocation spy 950 collects the process identifier of the parent process, the child process, system time, the method of invocation, etc. Once the desired information is collected as shown in block 1006, the process invocation spy 950 resumes execution of the child process as shown in block 1008.

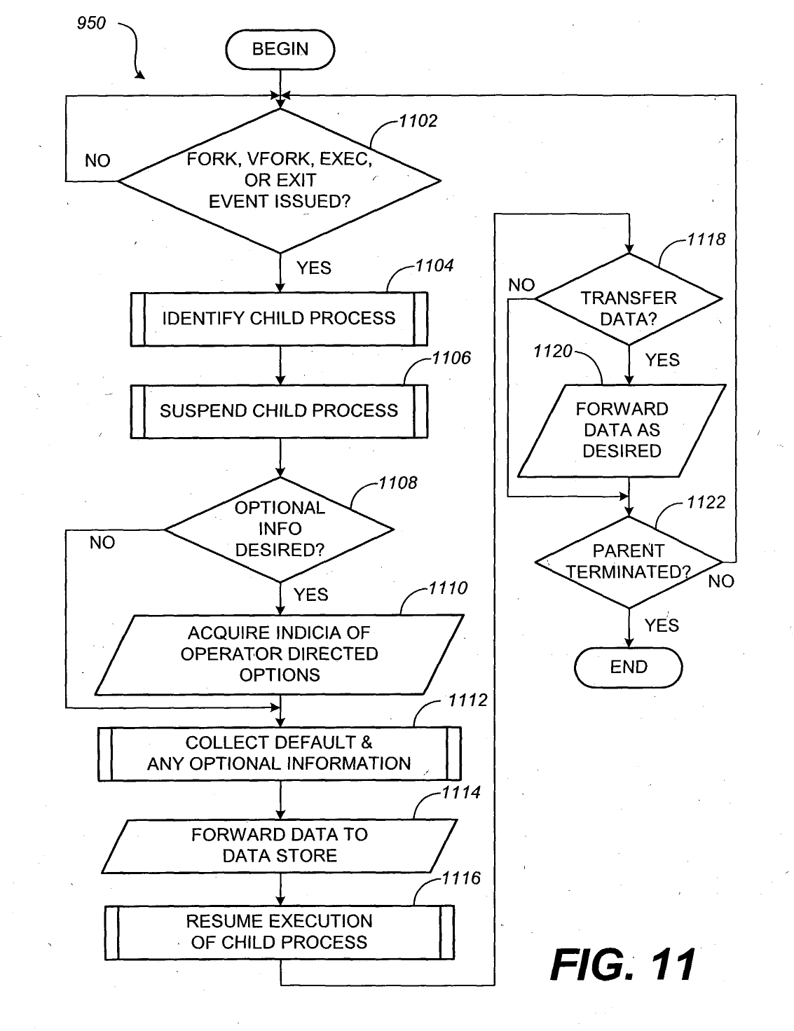

Reference is now directed to the flow diagram illustrated in FIG. 11, which illustrates an embodiment of a method 1100 for creating a process invocation tree from a parent process of interest. As shown in query 1102 of FIG. 11, the process invocation spy 950 begins by making a determination if the underlying computing system has processed one of a number of specific system events. When the computing system has not processed for example, a fork, vfork, exec, or exit event, as shown by the flow control arrow labeled “NO” exiting query 1102, the process invocation spy 950 is programmed to wait for the next event that meets the criteria of query 1102.

Otherwise, when the computing system (e.g., general-purpose computing device 800) processes an event that meets the criteria of query 1102 as indicated by the flow control arrow labeled “YES” exiting query 1102, the process invocation spy 950 identifies the child process that was created by the parent process of interest (block 1104). Having identified the child process (e.g., via the process identification number or some other method), process invocation spy 950 suspends the child process as indicated in block 1106.

Once the child process is suspended, the process invocation spy 950 is programmed to execute query 1108 to determine if optional information regarding the invocation of the child process is desired. When only a default set of parameters is desired, as indicated by the flow control arrow labeled “NO” exiting query 1108, the process invocation spy 950 bypasses block 1110. Otherwise, when operator identified parameters are also desired, as indicated by the flow control arrow labeled, “YES” exiting query 1108, the process invocation spy 950 acquires indicia of operated desired information concerning the computing system at the time the child process was invoked by the parent process of interest (block 1110).

Processing continues with block 1112 where both default and any optional desired information concerning the system at the time the child process was created is collected. Next, as illustrated in block 1114, the collected information is forwarded to a data store. Once, the system information is collected and forwarded to the data store, the process invocation spy 950 uses the debug interface of the present operating system to resume execution of the previously suspended child process as indicated in block 1116.

In the embodiment illustrated in FIG. 10, process invocation spy 950 includes logic to perform query 1118 to determine if it is desired to transfer data stored in data store to a file, another tool, a display monitor, a printer, and/or some other output device. When the result of query 1118 is affirmative as indicated by the flow control arrow labeled “YES” exiting query 1118, process invocation spy 950 forwards the invocation information from data store as desired (block 1120). Otherwise, when the result of query 1118 is negative, processing resumes with query 1122 where a determination is made if the parent process has terminated. When it is determined that the parent process has not terminated, process invocation spy 950 repeats steps 1102 through 1122 until the parent process of interest has terminated.

Any process descriptions or blocks in the flow diagrams presented in FIGS. 2, 3A, 10 and 11 should be understood to represent modules, segments, or portions of code or logic, which include one or more executable instructions for implementing specific logical functions or blocks in the associated process. Alternate implementations are included within the scope of the present system and method in which functions may be executed out of order from that shown or discussed, including substantially concurrently or in reverse order, depending on the functionality involved, as would be understood by those reasonably skilled in the art after having become familiar with the teachings of the present system and method.

We claim:

1. A computer-implemented method for creating a process invocation tree comprising:
identifying an event indicating that a parent process of interest has invoked a child process;
suspending execution of the child process;
collecting information-of-interest associated with the invocation of the child process; and
resuming execution of the child process.

2. The method of claim 1, further comprising:
determining when information concerning optional parameters-of-interest is desired; and
collecting information responsive to the optional parameters-of-interest.

3. The method of claim 2, wherein collecting information responsive to the optional parameters-of-interest comprises:
recording at least one optional parameter selected from the group consisting of time, user, rights, and system state.

4. The method of claim 1, further comprising:
forwarding the information-of-interest to a data store; and
when information concerning optional parameters-of-interest are desired, forwarding information responsive to the optional parameters-of-interest to the data store.

5. The method of claim 4, further comprising:
forwarding the information-of-interest and information responsive to optional parameters-of-interest from the data store to an output device.

6. The method of claim 1, wherein collecting information-of-interest comprises:
recording a first process identifier of the parent process of interest and a second process identifier of the child process.

7. The method of claim 1, wherein collecting information-of-interest comprises:
recording at least one of an invocation command argument and a program environment.

8. A system for creating a process invocation tree comprising:
means for identifying when a parent process of interest has created a child process; and
means for collecting information corresponding with the parent process of interest's creation of the child process.

9. The system of claim 8, wherein the means for identifying comprises interface logic.

10. The system of claim 8, further comprising:
means for forwarding the information corresponding with the parent process of interest's creation of the child process.

11. The system of claim 8, wherein the means for identifying comprises a debug interface.

12. The system of claim 8, wherein the means for collecting comprises information collection logic.

13. The system of claim 8, wherein the means for collecting is responsive to operator identified parameters.

14. The system of claim 13, wherein the means for collecting generates a log including at least one of an invocation command argument and a program environment.

15. The system of claim 13, wherein the means for collecting generates a log including at least one optional parameter selected from the group consisting of time, user, rights, and system state.

16. A system for creating a process invocation tree comprising:
a processor;
a memory coupled to the processor, the memory having an executable instruction set stored thereon, the instruction set comprising:
logic configured to suspend execution of a child process created by a parent process of interest;
logic configured to collect information responsive to the creation of the child process; and
logic configured to resume execution of the child process.

17. The system of claim 16, wherein the logic configured to configured to collect information uses a debug interface of an operating system.

18. The system of claim 16, wherein the logic configured to collect information generates a log including at least one of an invocation command argument and a program environment.

19. The system of claim 16, wherein the logic configured to collect information generates a log including at least one optional parameter selected from the group consisting of time, user, rights, and system state.

20. The system of claim 16, further comprising:
logic configured to forward the information.

21. A computer-readable medium having stored thereon an executable instruction set comprising logic that when executed by a processor, directs the processor to perform a method, comprising:
identifying an event indicating that a parent process of interest has invoked a child process;
suspending execution of the child process;
collecting information-of-interest associated with the invocation of the child process; and
resuming execution of the child process.

22. The method of claim 21, further comprising:
determining when information concerning optional parameters-of-interest is desired; and
collecting information responsive to the optional parameters-of-interest.

23. The method of claim 22, wherein collecting information responsive to the optional parameters-of-interest comprises:
recording at least one optional parameter selected from the group consisting of time, user, rights, and system state.

24. The method of claim 21, further comprising:
forwarding the information-of-interest to a data store; and
when information concerning optional parameters-of-interest are desired, forwarding information responsive to the optional parameters-of-interest to the data store.

25. The method of claim 24, further comprising:
forwarding the information-of-interest and information responsive to optional parameters-of-interest from the data store to an output device.

26. The method of claim 21, wherein collecting information-of-interest comprises:
recording a first process identifier of the parent process of interest and a second process identifier of the child process.

27. The method of claim 21, wherein collecting information-of-interest comprises:
recording at least one of an invocation command argument and a program environment.
